(19) United States
(12) Patent Application Publication
(10) Pub. No.: US 2008/0095973 A1
(43) Pub. Date: Apr. 24, 2008

(54) LASER TEXTURED FLOCKED SUBSTRATE

(75) Inventor: Louis Brown Abrams, Fort Collins, CO (US)

Correspondence Address: SHERIDAN ROSS PC, 1560 BROADWAY, SUITE 1200, DENVER, CO, 80202, US

(73) Assignee: HIGH VOLTAGE GRAPHICS, INC., Fort Collins, CO (US)

(21) Appl. No.: 11/874,146

(22) Filed: Oct. 17, 2007

Related U.S. Application Data
(60) Provisional application No. 60/890,129, filed on Feb. 15, 2007.
(60) Provisional application No. 60/829,759, filed on Oct. 17, 2006.

(51) Int. Cl. B32B 33/00; B05D 1/16; D05C 15/00

(52) U.S. Cl. 428/90; 156/72

(57) ABSTRACT

The present invention is directed to a flocked article and method for forming the flocked article in which a surface to be flocked is first roughened to provide a stronger bond with the flock adhesive. The flocked article includes a plurality of flock fibers adhered directly, or as an assembly containing flock, to an adhesive that is also adhered to a roughened surface of a material. The method of forming the flocked article can include forming a flocked article by contacting a laser-ablated roughened surface of a material with an adhesive that binds the material to a plurality of flock fibers or a flocked containing assembly containing a plurality of flock fibers.

### CROSS REFERENCE TO RELATED APPLICATION

The present application claims the benefits of U.S. Provisional Patent Application Ser. Nos. 60/829,759, filed Oct. 17, 2006, and 60/890,129, filed Feb. 15, 2007, all to Abrams, each of which is incorporated herein by this reference.

### FIELD

The invention relates generally to flocked articles and particularly to flocked articles having non-compatible inserts and a method for treating a surface of the non-compatible insert to produce a compatible surface on the insert, and more particularly to flocked articles having a non-compatible woven textile insert with a printed graphic image and to a laser-ablation process that produces a compatible woven textile insert.

### BACKGROUND

Flocked articles are used in a wide variety of applications, two popular applications being flocked textile decorations and flocked molded articles. Flock is a short precision cut or pulverized natural or synthetic fiber used to produce a velvet-like coating on cloth, rubber, film, or paper. Flock generally has a length between about 0.010 to 0.250 inches (0.25 mm to 6.25 mm).

FIGS. 1A and 1B depict typical prior art flocked articles with inserts, disclosed in U.S. patent application Ser. No. 11/460,519, filed Jul. 27, 2006. FIG. 1A depicts a flocked article 1100 with insert 1112 adhered by first adhesive 1120 to one side of porous film 1116, adhered by a second adhesive to the same one side of porous film 1116 and adjacent to insert 1112 are flock fibers 1104, and the opposing side of porous film 1116 is adhered to a third adhesive. FIG. 1B depicts a flocked article comprising insert 1112 and flock 1104 adhered a permanent adhesive 1600 to substrate 1700.

In these applications, it has been highly desired to have multi-media flocked articles incorporating one or more non-compatible inserts. Examples of insert materials include reflective materials (such as those having a metallic sheen or luster), textiles (such as a woven nylon material textile and twill), a hologram material, and the like. A problem with such articles is incompatibility of permanent adhesives with insert materials. The poor adhesion between permanent adhesives and many types of insert materials can cause the flock to separate from the insert material during prolonged use.

### SUMMARY

These and other needs are addressed by the various embodiments and configurations of the present invention. The present invention is directed to a flocked article in which one or more surfaces have been roughened, modified or otherwise removed by mechanical or chemical techniques, or by selected wavelengths of radiation, such as by a laser, or by ablating, vaporizing, mechanically drilling, cutting, and/or grinding, or by impingement (e.g. with a solid, liquid or gas), ultrasound, electrical discharges or plasmas.

In one preferred embodiment of the present invention is forming a flocked article by contacting a material with a roughened surface with an adhesive that binds the material to flock or to an assembly containing flock.

Another preferred embodiment of the invention is a flocked article having a plurality of flock fibers adhered directly, or as an assembly containing flock, to an adhesive that is also adhered to a roughened surface of a material.

Yet another preferred embodiment of the present invention is method of manufacturing a flocked article by roughening only a portion of one surface of a material, contacting that roughen surface with an adhesive that is part of a flock transfer assembly.

Still yet another preferred embodiment of the invention is a method of forming a flocked article by contacting a laser-ablated, roughened surface of a material with an adhesive that binds the material to a plurality of flock fibers or to a flocked assembly containing a plurality of flock fibers.

In a preferred embodiment, the surface is roughened with electromagnetic energy, preferably electromagnetic energy produced by a laser.

In a more preferred embodiment, part, if not substantially most, or all of the incompatible surface is removed by electromagnetic energy produced by a quantum-mechanical device to expose an underlying adherent surface that is more compatible and forms a stronger, more permanent bond with an adhesive; in an even more preferred embodiment the adherent is another adhesive. Some advantages of the adherent being another adhesive are faster, more economical, and stronger adhesive bonds between the adhesive and adherent (i.e., another adhesive).

A preferred embodiment is roughening the surface of the adherent to increase substantially the strength of adhesion with the adhesive, for example, surface roughening can improve mechanical interlocking and wetting and spreading of the adhesive on the adherent surface. Roughening can also provide for a cleaner surface.

Another preferred embodiment of the present invention is having an adhesive flow towards the heat source, or stated another way having a softened and/or liquefied adhesive flow along an increasing temperature gradient. A more preferred embodiment is having a softened and/or liquefied adhesive flow along an increasing temperature gradient and in the direction of the earth's gravitational pull. Yet another preferred embodiment is applying pressure to softened and/or liquefied adhesive to enhance the flow of the softened and/or liquefied adhesive along an increasing temperature gradient and/or in the direction of the earth's gravitational pull.

In an embodiment of the present invention a roughened insert is heated prior to contacting an adhesive. In another embodiment thermal energy is applied when contacting a roughened insert and an adhesive.

Roughening the surface of a material means any surface treatment that modifies or otherwise enhances one or more of a chemical, physical, or mechanical property of a surface or portion of a surface. A chemical modification of a surface means changing the chemical composition of the surface or a portion of the surface, such as but not limited to introducing new chemical entities on the surface, removing chemical entities from the surface, exposing a surface having a different chemical composition, or any other chemical changes that affect positively the ability of the surface to form an adhesive bond or create an adhesive force, specifically the chemical modification improves the ability of the surface to form an adhesive bond and create an adhesive force with a permanent adhesive. Physical modification of a surface means changing at least one physical property of the surface, such as but not limited to, surface energy, degree of surface crystallinity and/or amorphousness, surface electron density, surface dipoles, surface charge, surface double-layer properties, band structure, Fermi levels, or any other physical property changes that affect positively the ability of the surface to form an adhesive bond or create an adhesive force, specifically the physical modification improves the ability of the surface to form adhesive bonds and create an adhesive force with a permanent adhesive. Mechanical modifications to a surface means any changes to the surface such as but not limited to surface topology, surface structure, surface geometry, surface roughness, or any other mechanical property associated with the surface that affects positively the ability of the surface to form an adhesive bond or create an adhesive force, specifically the mechanical modification improves the ability of the surface to form adhesive bonds and create an adhesive force with a permanent adhesive.

The present invention can provide for one or more of the following advantages over the prior art: substantially reduce, if not eliminate, movement and misalignment of the insert; reduce or eliminate adhesive overflow or oozing during lamination; substantially reduce fabrication time (for example, reducing lamination time by at least a factor of two); improve adhesion of the insert; enhance precision in fabrication; decrease or eliminate off-spec product; convert a non-compatible insert into a compatible insert; covert a low surface energy insert into a high surface energy insert that is wettable by an adhesive; provide for a more controllable, precise, surface roughening process; and provide for a cleaner, safer, faster, and more economical and ecological surface treatment process. These and other advantages will be apparent from the invention disclosed herein.

The above-described embodiments and configurations are neither complete nor exhaustive. As will be appreciated, other embodiments of the invention are possible utilizing, alone or in combination, one or more of the features set forth above or described in detail below.

As used herein, “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

### BRIEF DESCRIPTION OF THE DRAWINGS

FIGS. 1A and 1B are side views of flocked articles with inserts according to the prior art;

FIGS. 2A-F are side, top, and bottom views of transfers according to an embodiment of the present invention;

FIG. 3 is a schematic flowchart of a manufacturing process according to an embodiment of the present invention;

FIGS. 4A-F are side and top views of transfers according to an embodiment of the present invention;

FIGS. 5A-Q are longitudinal, cross-sectional, and top views of laser-ablated inserts according to an embodiment of the present invention; and

FIGS. 6A and 6B are side views of a manufacturing process according to an embodiment of the present invention.

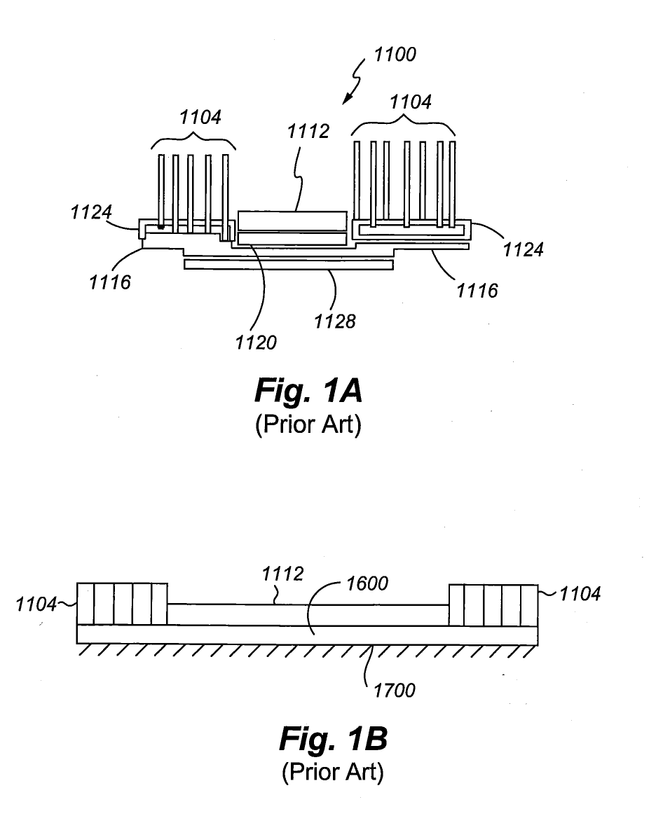

### DETAILED DESCRIPTION

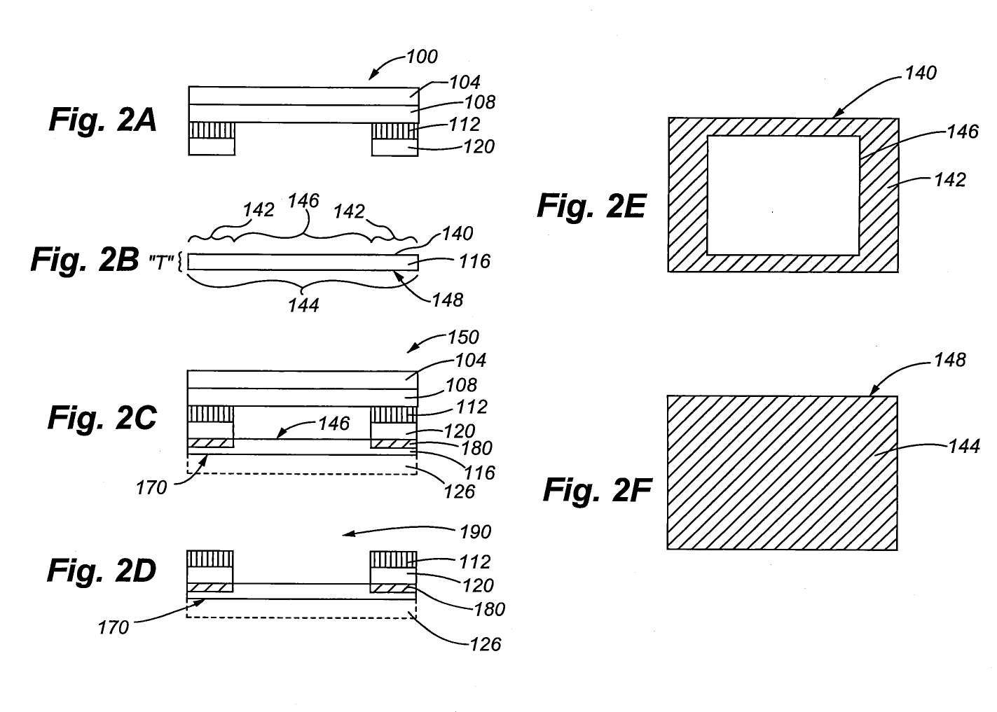

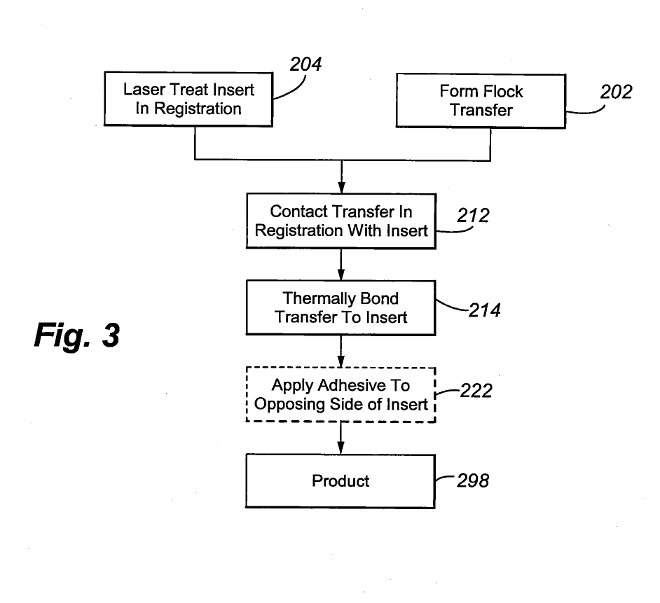

Referring to FIGS. 2A-F, article 100 (FIG. 2A) includes a permanent adhesive 120, a release sheet 104, flock 112 applied in a desired pattern, and a release adhesive 108 that adheres the flock to the release sheet. Article 100 is formed in step 202 of the process depicted in FIG. 3; the method of forming such a transfer is further discussed in U.S. patent application Ser. No. 09/621,830, filed Jul. 24, 2000; Ser. No. 09/735,721, filed Dec. 13, 2000; Ser. No. 10/455,541, filed Jun. 4, 2003; Ser. No. 10/455,575, filed Jun. 4, 2003; and Ser. No. 10/670,091, filed Jul. 23, 2003, all to Abrams.

Prior to contact with flock, release adhesive 108 is first applied to carrier sheet 104. It is desired that, when the flock fibers are detached from the release adhesive, the fibers are substantially free of release adhesive. The release adhesive may be applied to carrier sheet 104 in the form of a solution or emulsion. The release adhesive may be applied on the carrier in the perimeter shape of the desired design or without regard to the overall design desired. The release adhesive may be applied by any suitable technique such as, for example, by applying the release adhesive with rollers or spraying the release adhesive.

The flock is then contacted with the release adhesive using known techniques, such as electrostatic and gravity flocking techniques. It is desired that at least most of the flock fibers are orthogonal or perpendicular to insert 116 (FIG. 2B) and solid, permanent adhesive 120 and carrier sheet 104.

The flock may be pre-colored or sublimation printed. In sublimation printing, the exposed ends of the flocked surface are sublimation printed to provide a desired design on the flock. Sublimation printing is described in co-pending U.S. application Ser. Nos. 10/614,340 filed Jul. 3, 2003; 11/139,439 filed May 26, 2005; and 11/036,887 filed Jan. 14, 2005, all to Abrams. As will be appreciated, common ways of performing sublimation ink direct printing include inkjet or screen sublimation ink printing and sublimation transfer printing using devices such as an inkjet dye sub printer, a ribbon-based dye sub printer, a hybrid sublimation printer, and a small dye sub ribbon-based printer. In inkjet (direct) sublimation ink printing, a special heat sensitive dye is used in a computer-controlled printer, such as an HP 550™, or Mimaki JV4™ to sublimation print the ink onto the flock fibers through vapor phase transportation of the ink from the printer to the flock fibers. The transferred dye is then heat and pressure thermofixed and thereby enters the amorphous areas of the fiber matrix. Commonly, the color must go all the way down the fiber.

The release or carrier sheet 104 can be any substrate that is dimensionally stable under the conditions of temperature and pressure encountered during the process. The carrier sheet 104 is preferably a porous film, such as a porous film, coated with release adhesive 108, which is preferably a water-based release adhesive. A preferred porous film is further discussed by Pekala in U.S. Pat. No. 6,025,068. A particularly preferred porous film is sold by PPG Industries Inc. under the trade name TESLIN™. Battery separator membranes can also be used. Examples include Daramic Industrial CL™ sold by Daramic, Inc., and the battery separator membranes sold by Celgard or by Daramic, Inc. under the trade name Artisyn™. Artisyn™ is an uncoated, nono-layer, highly filled polyolefin sheet. Typically, but not always, the carrier is a discontinuous as opposed to a continuous sheet on a running web line. The carrier 104 can be any low-cost, dimensionally stable substrate, such as paper, plastic film, and the like, preferably in the form of a discontinuous sheet or a running web line material.

The release adhesive 108 is selected such that the bonding force between the release adhesive 108 and the flock 112 is less than the bonding force between the unactivated adhesive 120 and flock 112. The release adhesive 108 can be any adhesive that adheres more strongly to the carrier sheet than the flock fibers but adheres to both enough to hold them together. For example, the release adhesive 108 can be any temporary adhesive, such as a resin or a copolymer, e.g., a polyvinyl acetate, polyvinyl alcohol, polyvinyl chloride, polyvinyl butyral, acrylic resin, polyurethane, polyester, polyamides, cellulose derivatives, rubber derivatives, starch, casein, dextrin, gum arabic, carboxymethyl cellulose, rosin, silicone, or compositions containing two or more of these ingredients.

The flock fibers 112 can be formed from any natural or synthetic material. Synthetic material includes vinyl, rayons, nylons, polyamides, polyesters such as terephthalate polymers, such as poly(ethylene terephthalate) and poly(cyclohexylene-dimethylene terephthalate), and acrylic, and natural material includes cotton and wool. In one configuration, a conductive coating or finish is applied continuously or discontinuously over the exterior surface of the flock fibers to permit the flock fibers to hold an electrical charge. The flock fibers 112 may be pre-colored (yam-dyed or spun dyed) before application to the release adhesive 108 (or adhesive 120) or after the carrier 104 is removed, such as by sublimation dye transfer printed.

The free ends of the flock are coated with a permanent adhesive, such as a binder and/or hot melt adhesive 120. This process is discussed in U.S. Pat. Nos. 4,810,549; 5,207,851; 5,597,637; 5,858,156; 6,010,764; 6,083,332; and 6,110,560, all to Abrams. A suitable binder adhesive is a water-based acrylic that binds the flock together as a unit. Adhesive 120 can contain a binder adhesive, a hot melt adhesive, or two adhesives applied separately and sequentially.

The adhesive 120 can be any suitable water- or solvent-based adhesive, preferably adhesive 120 is an activatable, permanent adhesive in the form of a pre-formed self-supporting film before contact with the flock. Adhesive 120 is preferably is polyester or nylon. Adhesive 120 is activated fully when it is heated above an activation temperature for a sufficient period of time. As will be appreciated, thermosetting adhesives solidify, activate, and/or set irreversibly (that is, become infusible and relatively insoluble in solvents) when chemical entities comprising the thermosetting adhesive chemically react (that is, cross-link) to form covalent bonds at least mostly between the reactive chemical entities comprising the thermosetting adhesive. The chemical, cross-lining reaction is typically initiated and/or maintained by a chemical initiator, thermal energy or radiation (such as, an electron beam or electromagnetic energy). The adhesive is preferably a high temperature permanent adhesive, such as polybenzimidazoles and silica-boric acid mixtures or cements, hot-melt adhesives, thermosetting adhesives, thermoplastic adhesives, polyurethane, polyester, and combinations and blends thereof. “Hot-melt adhesives” generally refer to a solid material that forms an adhesive bond upon heating and subsequent cooling, “thermosetting adhesives” generally refer to a polymer that solidifies or “sets” irreversibly when heated, and “thermoplastic” generally refers to a polymer that softens when heated and returns to its original physical state when cooled to room temperature. The irreversible setting of a thermosetting adhesive is commonly affected by cross-linking of at least most, if not all, of the cross-linking reactive entities contained in the adhesive polymer.

The pre-formed, self-supporting adhesive film can include fine particles of polymers or copolymers, as well as one or more of plasticizer(s), stabilizer(s), curing agent(s) (such as an isocyanate), pigment(s), etc. The pigment, if any, determines the color and opacity of the adhesive film. The stabilizer, used when pigment is added, prevents discoloration of the resin film. Thermosetting adhesives can include curing agents such as organic peroxides or sulfur. Examples of thermosetting adhesives include polyethylene, polyurethanes, polyester, polyamides, phenolics, alkyds, amino resins, polyesters, epoxides, and silicones.

In step 204 selected surfaces of insert 116 (FIG. 2B) are treated to promote and improve adhesion to adhesive 120 to the treated compared to untreated surfaces of insert 116.

The insert 116 can be any metallic or synthetic or natural polymeric design media, and can be woven or non-woven design media. Examples of insert materials include reflective materials (such as those having a metallic sheen or luster), textiles (such as a woven nylon or polyester material textile and twill), a material containing a hologram or print image, and the like. In one configuration, the insert 116 is an extremely durable, woven nylon textile that strongly resembles embroidery. In one configuration, the insert 116 is a twill material. Another particularly preferred insert is an embossed or molded article, preferably containing a permanently raised three-dimensional surface or pattern in the textile material, such as but not limited in form to appliqués or transfers. Another preferred insert 116 is a woven textile product sold under the trade name ObiTex™ by Fiberlok®, having an enhanced surface texture and luster that provides an embroidered or hand-stitched embroidered appearance. A preferred woven textile insert can be a loosely, woven polyester with increased surface dimensionality or character, with or without a printed image, such as a sublimation dye printed image. Exemplary heat transfers that can be modified by the present invention are Lextra 3D™ with Tackle Twill and Lextra 3D NX™, both sold by Fiberlok®. In one configuration, the insert 116 is formed from one or more polymeric light diffusing films, such as polycarbonate and/or polyester light diffusion films sold under the trade names Makrofol™ and/or Bayfol™. The films are preferably metal-containing and have a first and/or second surface gloss (60° angle with black inked second surface) of at least about 50 gloss units, more preferably of at least about 75 gloss units, and even more preferably of at least about 75 gloss units, first and/or second surface roughnesses (R3Z) of no more than about 20 microns, more preferably of no more than about 3 microns, and even more preferably of no more than about 1 micron, and a luminous transmittance of no more than about 50%, more preferably no more than about 5%, and even more preferably no more than about 1%. The insert 116 preferably has a metallic or nonmetallic sheen and a gloss/fine matte and a thickness of no more than about 0.5 inches, more preferably of no more than about 0.25 inches, and even more preferably of no more than about 0.20 inches. A particularly preferred insert is Makrofol DPF 5072™. An exemplary heat transfer that may be modified by the present invention is Lextra 3D™ with metallic textile insert sold by Fiberlok®.

To understand the need for roughening of the insert 116 or adhesive 120, one should understand the theories behind adhesion. While not wishing to be bound by any theory, several theories have been proposed to explain adhesion, the five most commonly accepted theories being: 1) mechanical interlock, 2) dispersive, 3) chemisorption, 4) electrostatic, and 5) diffusion. No one theory explains completely adhesion or the adhesion process. However, one should understand the five theories and how they impact the adhesion of materials being attached. The five theories are summarized below.

The mechanical interlocking theory postulates good adhesion when an adhesive penetrates a roughen adherent surface having crevices, pores, and/or holes, and is cured within the crevices, pores and/or pores of the adherent, thereby mechanically interlocking the cured adhesive with the adherent. Optimal mechanical interlocking of the adhesive to the adherent occurs when the adhesive wets and/or penetrates the roughen adherent surface. Maximum bond strength is typically the mechanical strength of the adhesive.

Dispersive theory involves intermolecular Van der Waals dispersive forces between closely adjoining surfaces due to Keesom and/or London forces between the adherent and adhesive. Keesom and London forces are due to dipole-dipole attractive forces. Optimal adhesion occurs when the adhesive and the adherent are in intermolecular contact, optimal intermolecular contact is achieved when the adhesive has a lower surface energy than the adherent and is able to wet and spread on the substrate surface. The strength of a Van der Waals dispersive force is typically about 0.1-40 KJ/mole and varies by 1/r⁶ power, where r is the distance separating the dipoles.

In the chemisorption theory an ionic or covalent bond is formed between the adhesive and the adherent, typically bond formation is across the adhesive adherent interface, either directly across the interface or through a chemical coupling agent. In some instances the adherent surface is chemically modified or derivatized to facilitate the formation of chemical bonds. The adhesive strength of a covalent bond is typically in the range of about 60-700 KJ/mole.

In the electrostatic theory the adhesive force is attributed to dipole-dipole attractive forces across the boundary separating the adhesive and adherent, the dipoles can be permanent or induced. The attractive force is typically the order of 4-20 KJ/mole and varies by 1/r³, where r is the distance separating the dipoles.

The diffusion theory is typically associated with polymer-polymer adhesion where the polymeric adhesive and adherent inter-penetrate. Optimal interpenetration typically occurs when the adhesive and adherent are mutually compatible and miscible and where the movement and entanglement of the long polymeric chains comprising the adhesive and adherent occurs. Diffusion is affected by contact time, temperature, and molecular properties, such as but not limited to: molecular weight (e.g., number average, weight average or polydispersity average); physical form (i.e., liquid or solid); and physical properties, such as for example, crystallinity, degree of cross-linking, and solubility parameters.

Many insert materials have relatively low surface energies and/or relatively smooth surfaces. Typically, such surfaces are difficult for permanent adhesives to bond firmly to. The relative surface energies of adhesive 120 and the surface 140 of insert 116 contacting adhesive 120 determine the ability of the adhesive to form an adhesive bond with the surface. If the surface of insert 116 in contact with adhesive 120 has a lower surface energy (or surface tension) than adhesive 120 the adhesive will not wet the insert surface. Or stated another way, if the surface tension of adhesive 120 is at least less than or about equal to the surface energy of insert 116 surface in contact with adhesive 120, the adhesive will wet the surface of insert 116. Or stated yet another way, for the surface of insert 116 to be wetted by adhesive 120, the surface energy of adhesive 120 is at least less than or equal to the surface energy of the surface of insert 116.

It will also be appreciated that similar or substantially similar substances have similar surface energies and, therefore, will wet each other. If the portion of insert surface 140 in contact with adhesive 120 is similar to or substantially similar to adhesive 120, adhesive 120 will wet the surface.

According to the present invention, the insert surface to be contacted with a permanent adhesive is roughened, textured or etched to increase the adhesion of the permanent adhesive with the insert surface. While not wanting to be bound by any theory, any increase in the degree of surface roughness can increase the mechanical interlocking of the permanent adhesive with the insert thereby increase the degree of adhesion between the permanent adhesive and the insert. Preferably laser-ablation of the surface increases at least one of the following standard roughness parameters: roughness average, Rₐ; root mean square roughness, R_{q}; maximum height of profile, Rₜ; maximum profile valley depth, Rᵥ or Rₘ; maximum profile peak height, Rₚ; average maximum profile peak height, Rₚₘ; average maximum height of the profile, R_{z}; maximum roughness depth, Rₘₐₓ; mean height of profile irregularities, R_{c}; roughness height, R_{z(iso)}; maximum height of profile, R_{y}; waviness height, Wₜ or W; mean spacing of local peaks of profile, S; means spacing of profile irregularities, Sₘ or RSₘ; profile peak density, D; peak count or peak density, P_{c}; high spot count, HSC; average wavelength of profile, λₐ; root mean square wavelength of profile, λ_{q}; average absolute slope, Δₐ; root means square slope, Δ_{q}; developed profile length, Lₒ; profile length ratio, Iᵣ; and skewness, Rₛₖ or Sₖ. Even more preferred are roughness features that increase the number, density and/or extent of crevices, pores, cavities, holes, undercuts, overhangs, open-chambers and similar surface irregularities in the laser treated compared to the untreated insert. As can be appreciated, the surface roughening process is not limited to specific surface patterns, topologies, or modifications.

Other surface treatment techniques may be employed. For example, chemical etching and/or mechanical roughening techniques may be used for certain types of insert materials. Any surface treatment that provides a rough pattern or varied topology for attachment to the adhesive may be used. Laser-ablation is preferred for its ease of use, economics, precision, safety, and environmental benefits, especially when processing woven inserts. Mechanical and chemical techniques can provide benefits when processing metallic inserts and some types of polymeric inserts.

Laser-ablation preferably provides a treated insert surface with a surface energy substantially at least about equal to or greater than the surface energy of the permanent adhesive to be adhered to the treated surface, more preferably by at least about 5% higher surface energy than the adhesive, even more preferably by at least about 10%, and even more preferably by at least about 25% greater surface energy than the adhesive. The surface energy modification imparted by the laser can be physical (e.g., roughening or smoothing, melting and re-solidification thereby modifying surface crystallinity and/or molecular ordering on the surface) and/or chemical (e.g., inducing chemical changes, re-arrangements, transformations or reactions). Laser-ablation can also remove and/or convert a low energy surface to expose and/or produce a surface substantially at least about equal to or greater than the surface energy of the material to be adhered to.

The laser can be any laser: comprising a lasing material or gain medium; having any coherency; comprising any line width; producing a laser beam of any wavelength; producing a pulsed or continuous laser beam; and providing any energy output. Preferably the laser produces at least enough energy to sufficiently vaporize the material being removed from the insert to roughen, etch, and/or modify the insert surface. In the more preferred embodiment, lasers having an energy range of about 1000 to 2500 watts.

The incident angle of the laser beam with the surface of the insert being treated can be about any angle of about −15 to 195°, wherein when the laser beam impinging the surface is perpendicular to the impinged surface the laser beam is at a 90° degree angle. The laser impinging angle can be fixed, as for example when burning holes, or varied, as for example but not limited to providing undercuts, pores or irregular rough surfaces. The impinging laser beam and insert can be dynamically and/or variably indexed relative to each other, that is, the point and/or angle of impingement of the laser beam on the insert surface is varied to move along or under-cut the insert surface by moving at least one of the laser beam and insert relative the other. Indexing can be achieved by manual, mechanical, and/or analogue or digital computer control.

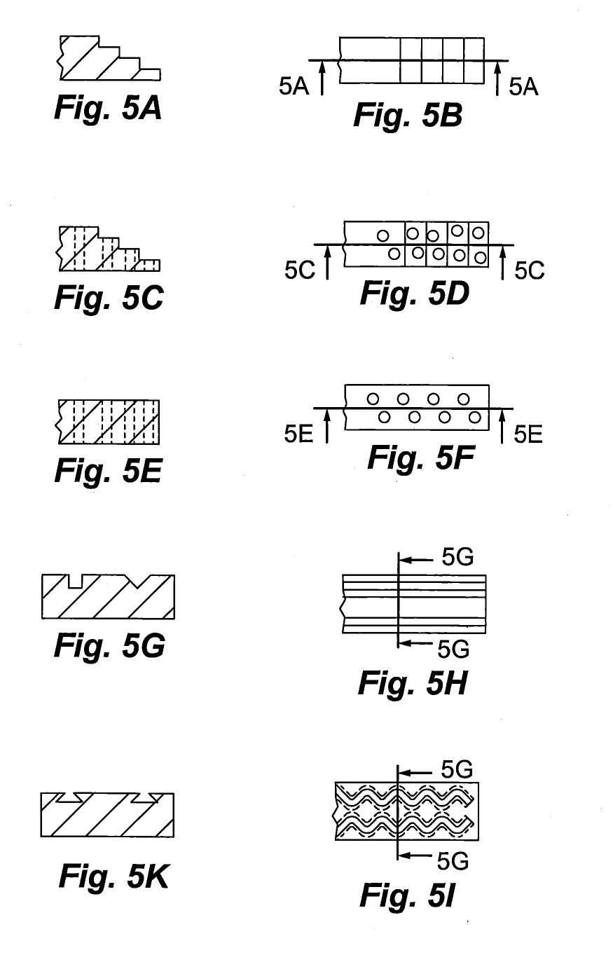

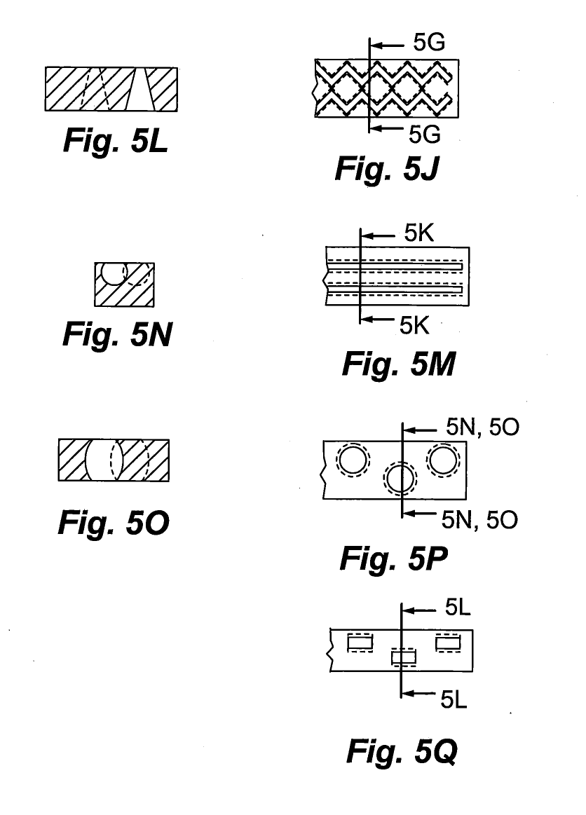

Laser-ablation provides for unexpected and unique advantages for providing controlled surface roughness or geometries of insert 116 for enhanced adhesion to the permanent adhesive, such as for example: a) a “stair-case”, FIG. 5A is a longitudinal, cut-away view and FIG. 5B is a top view; b) a “stair-case” with holes, FIG. 5C is a longitudinal, cut-away view and FIG. 5D is a top view; c) drilling holes through the insert, FIG. 5E is a longitudinal, cut-away view and FIG. 5F is a top view; d) cutting groves, FIG. 5G is a cross-sectional, cut away view of two representative groove geometries and FIGS. 5H-J are top views of three representative groove patterns, 5H depicts a straight-line groove pattern, 5I depicts a wavy line groove pattern, and 5J depicts a zig-zag groove pattern; e) grooves with an under-cut, FIGS. 5K and 5L are cross-sectional, cut-away views and FIGS. 5M and 5Q are top views; f) pores, FIGS. 5N and 5O are cross-sectional, cut-away views and FIG. 5P is a top view; g) combinations of one or more surface roughness geometries; h) surface roughness geometries distributed in an ordered or disordered manner on the insert surface; or i) surface roughness geometries that vary in shape, size, length, width, depth, and/or other surface roughness parameters. The examples depicted in FIGS. 5A-P are illustrative, non-limiting examples of the surface laser-ablations for enhancing the adhesive bond of an insert to a permanent adhesive. As can be appreciated, the type or geometry of the roughness imparted to an insert can be varied, removing and/or penetrating at least some of the insert surface or removing at least most, if not all, of the insert within selected area portions of the insert. The depth of the holes, grooves, grooves with under-cut, pores, cavities, open-chambers and such is preferably at least about 20% of thickness “T” of the insert 116, more preferably at least 50% of thickness “T”, and even more preferably at least 80% of thickness “T”, and yet even more preferably completely through the thickness of “T”. As will be appreciated, the optimal depth can vary depending on the tensile strength of insert 116 and the geometry of surface-ablation. Laser ablation also provides for a clean, safe, fast, economical, and ecological surface treatment process. These and other advantages are not typically provided for in chemical or mechanical surface treatments of the insert.

Laser-ablation is preferably provided to the area(s) of insert 116 in registration with the area(s) that permanent adhesive(s) will come in contact with the insert. Area 142, FIGS. 2B and 2E, of surface 140 of insert 116 is laser-abraded in step 204. Area 144 of surface 148, FIGS. 2B and 2F, of insert 116 is optionally laser-abraded in step 204 if a second adhesive 126, FIGS. 2C and 2D, is applied in optional step 222 to the insert surface side 148 opposing flock 112. The laser-ablated area 142 is in registration with the permanent adhesion area 120 contacting insert 116 in step 212. As will be appreciated, any laser ablation encroachment in area 146, FIGS. 2B and 2E, of insert side 140 is undesirable and can decrease the quality and artistic value of insert 116. Any misalignment in the registration of surface-ablated area 142 with adhesive 120 can decrease the adhesion of permanent adhesive 120 to insert 116 and the utility and value of the product.

The laser-ablation treatment can vary within the treatment areas, the depth of cutting and/or removal can be incremental, such as, a laser-ablation treatment in areal zone i cuts to a depth of Xᵢ and/or removes a volume per-cent νᵢ, a laser-ablation treatment in areal zone i+1 cuts to a depth of Xᵢ₊₁ and/or removes a volume per-cent νᵢ₊₁, and so forth to an n^{th} laser-ablation treatment in areal zone n cuts to a depth of Xₙ and/or removes a volume per-cent νₙ, where n can be any real number greater than zero, T≧Xᵢ≧0, X_{i→n} can vary randomly or be sequentially ordered, such as, Xᵢ≧Xᵢ₊₁≧ . . . ≧Xₙ or Xᵢ≦Xᵢ₊₁≦ . . . ≦Xₙ, and 0≦νₙ≦100, ν_{i→n} can vary randomly or can be sequentially ordered, such as, νᵢ≧νᵢ₊₁≧ . . . ≧νₙ or νᵢ≦νᵢ₊₁≦ . . . ≦νₙ.

In step 214, flock transfer 100 is thermally bonded to insert 116 (FIGS. 2C and 2D). Preferably permanent adhesive 120 of flocked transfer 100 is an A- or B-staged thermosetting adhesive that is at least most fully B- or C-staged during thermal bonding step 214. A-stage of a thermosetting adhesive means the early stage of the cross-linking reactions of the adhesive, wherein the adhesive is liquefied by heat and soluble in certain liquids. B-stage of a thermosetting adhesive means an intermediate stage in the reaction of a thermosetting adhesive where the adhesive may not entirely fuse or dissolve, that is, the adhesive softens when heated and swells when in contact with certain liquids. C-stage of a thermosetting adhesive means the final stage of the cross-linking reaction of a thermosetting adhesive, the adhesive is substantially insoluble and infusible, that is, the adhesive is substantially incapable of being softened or liquefied by heat.

The softened or liquefied (A- and/or B-stage) permanent adhesive 120 should be capable of wetting the treated insert surface 142 and flow, that is, have a sufficiently low viscosity, to flow on the articulated, roughened surface 142, such that substantially at least most of the roughened laser treated surface area 142 is contacting adhesive 120 and at least most of roughened surface area 142 is wetted by adhesive 120. It is further appreciated that the ability of adhesive 120 to flow into and/or along crevices, pores, cavities, holes, undercuts, open-chambers, and such of the exposed or modified surface is dependent on the surface energy (or surface tension) and/or viscosity of adhesive 120 relative to the surface energy of roughened surface 142 and the relative size and/or geometries of the crevices, pores, cavities, holes, undercuts, open-chambers, and such of the exposed or modified surface. It will also be appreciated that typically a low surface energy and/or viscosity of liquefied or softened adhesive 120 is needed for the adhesive to flow into, intermingle, and/or contact the surfaces comprising relatively smaller crevices, pores, cavities, holes, undercuts, open-chambers, and such than to flow into, intermingle, and/or contact the surfaces of larger crevices, pores, cavities, and such under more viscous conditions; that is, the surface energy of liquefied or softened adhesive 120 is at least about equal to or at least about less than the surface energy of laser-ablated surface 142.

Another preferred embodiment of the invention includes directionally controlling adhesive flow when thermally bonding an adhesive to inset 116 in step 214, to affect optimal adhesion. It has been found that optimal adhesion is achieved when at least most of the adhesive flow is towards and/or into the laser-ablated surface being bonded to.

Yet another preferred embodiment is directionally controlling thermal energy flow during the thermal bonding process; a more preferred embodiment comprises the laser-ablated insert surface being at a higher temperature than the bulk temperature of the adhesive contacting and being bonded to the laser-ablated surface; that is, at least some if not at least most of the adhesive flow is in the direction of the rising temperature gradient, or stated another way, adhesive flow is in the direction of and/or into the articulated laser-ablated insert surface, such as but not limited to the cavities, crevices, undercuts, holes, and/or such.

Yet another embodiment of the present invention is controlling heat and adhesive flows during the lamination process through the thermal properties of the insert, as for example, but limited to controlling the thickness of the insert and the heat conductive properties of the insert, or at least that part of the insert contacting the adhesive of the insert. Thinner, more thermally conductive insert materials are more preferred than thicker, less thermally conductive materials, the thinner and/or more thermally conductive materials provide for steeper (greater) heat gradients, more effective and efficient heat transfer to the adhesive to soften and/or liquefy the adhesive, and better adhesive flow, thereby affording better, more rapid adhesion of the insert to the adhesive.

Still yet another embodiment includes applying pressure during thermal bonding. The application of pressure in conjunction with the temperature gradient can provide for an additional vector directing at least most of the adhesive flow in the direction of the articulated, laser-ablated insert surface.

It is preferred that adhesive 120 is at least most fully B-staged during thermal bonding step 212; it is even more preferred that adhesive 120 is at least most fully C-stage during step 212. The B- and/or C-staged adhesive is at least most fully and permanently interlocked with laser-roughened insert 116. While not wanting to be bound by theory or limited to the following illustrative examples: it can be appreciated that thermosetting adhesive cured with laser articulated roughened grooves 550 and/or 555 forms substantially the equivalent of a dove-tail joint, known of its structural strength and integrity; it can also be appreciated that thermosetting adhesive cured within grooves 560 and/or 565 form the substantially the equivalent of a mechanical fastener, also known for their structural strength and integrity.

Adhesion zone 180 comprises adhesive 120 and insert 116 wherein the adhesive interactions of adhesive 120 and insert 116 within zone 180 is at least one of the following: mechanical, chemical, and physical.

The process depicted in FIG. 3 can be complete after thermally bonding the transfer 100 to the insert 116 in step 214 to form product 298 or a third adhesive 126 can be applied in optional step 222 to form product 298.

In optional step 222 a third adhesive 126 is applied to opposing insert surface 148. Third adhesive 126 can be any suitable adhesive meeting the requirements of adhesive 120 as disclosed above. Adhesives 126 and 120 can be the same or differ. Depending on the product application of product 216, adhesive 148 can be a thermoplastic or thermosetting adhesive. The wetting and viscosity properties of adhesive 126 relative to insert laser-ablated surface 144 are the same as disclosed above for wetting and viscosity properties of adhesive 120 relative to insert laser-ablated surface 142. The surface ablation profiles 142 and 144 can be substantially equivalent or substantially different. Preferably the physical and chemical properties of the laser-ablated insert surfaces 142 and 144 respectively complement adhesives 120 and 126 to provide optimum adhesive wetting, flow properties, and adhesion to the respective ablated insert surface. As can be appreciated, providing a thermal gradient and pressure to provide adhesive flow of adhesive 126 towards laser-ablated surface 144 is preferred, as disclosed above for the adhesive flow of adhesive 120 towards laser-ablated surface 142.

More preferably adhesive 126 is a thermosetting adhesive. More preferably adhesive 126 is substantially chemically equivalent or chemically compatible with adhesive 120. Adhesion zone 180 is in registration with adhesive 120 and can extend from adhesive 120 to adhesive 126 at least in part or at most in all, when the laser-ablation process perforates insert 116 and/or removes at least most of insert 116 in a given area. In such a situation, adhesives 120 and 126 can contact one another and/or form an interface, and while not wanting to be bound by theory, chemically equivalent and/or compatible adhesives 120 and 126 are capable of forming at least one of the following adhesive bonds: a) a diffusion bond, wherein compatible adhesives diffuse into one another, intermingling and forming an interfacial bond; b) covalent bonds, wherein reactive entities within adhesives 120 and 126 chemically react with one another, that is cross-link to form covalent bonds between adhesives 120 and 126; c) dispersive or electrostatic bonds, wherein polarizable groups (such as for example, the carbonyl and/or amino groups in polyurethanes and polyester adhesives) within the adhesives give rise to short and long range dipole-dipole interactions.

Step 214 and optional step 222 can be preformed substantially simultaneously, or optional step 222 can be preformed before step 214, or as disclosed above optional step 222 can be preformed after step 214. In an embodiment where optional step 222 is preformed substantially simultaneously with thermal bonding step 214, the diffusion adhesion of adhesives 120 and 126 can be enhanced when softened and/or liquefied chemically compatible and/or chemically equivalent adhesives intermingle, and while not wanting to be bound by theory can form at least one of the following adhesive bonds: mechanically interlock (for example a thermoplastic adhesive mechanically interlocking with a previously C-staged thermosetting adhesive); dispersive; chemisorption (for example, two thermosetting adhesive cross-linking with one another); electrostatic; or diffusion (for example, the polymeric chains of the two adhesives inter-mingling and inter-tangling). As can be appreciated, the intermingling of two chemically incompatible adhesives 120 and 126 can degrade the adhesion between the adhesives.

Adhesion zones 170 and 180 depict the adhesive interaction of adhesive 126 with the roughened surface 144 to form adhesion zone 170, wherein the adhesive interactions within zone 170 are at least one of the following: mechanical, chemical, and physical, and the adhesive interaction of adhesive 120 with optional adhesive 126 to form adhesive zone 180 at least in part. Adhesion zone 180 is positioned between adhesives 120 and 126, and can comprise at least in part the zone where adhesive 120 and optional adhesive 126 come in direct contact (not depicted in FIGS. 2C and 2D). The adhesive interactions of adhesive 120 and optional adhesive 126 are at least one of the following: mechanical, chemical and physical.

Where durability is not a critical concern and service temperature of product 298 is substantially below the melt temperature of thermoplastic adhesive 126, a thermoplastic adhesive can be sufficient. Thermoplastic adhesive means an adhesive capable of being repeatedly softened by heating above its melt temperature and hardened by cooling below its melt temperature; while not wanting to be bound by theory, the mechanical adhesion provided by a thermoplastic to a laser ablated surface can be the same as that provided (and disclosed above) for a thermosetting adhesive, as for example where the adhesive flows into the roughened ablated surface and hardens to form the equivalent of a mechanical joint or fastener.

Product 298 can or cannot include carrier sheet 104 and release 108 as respectively depicted in articles 150 and 190, respectively in FIGS. 2C and 2D.

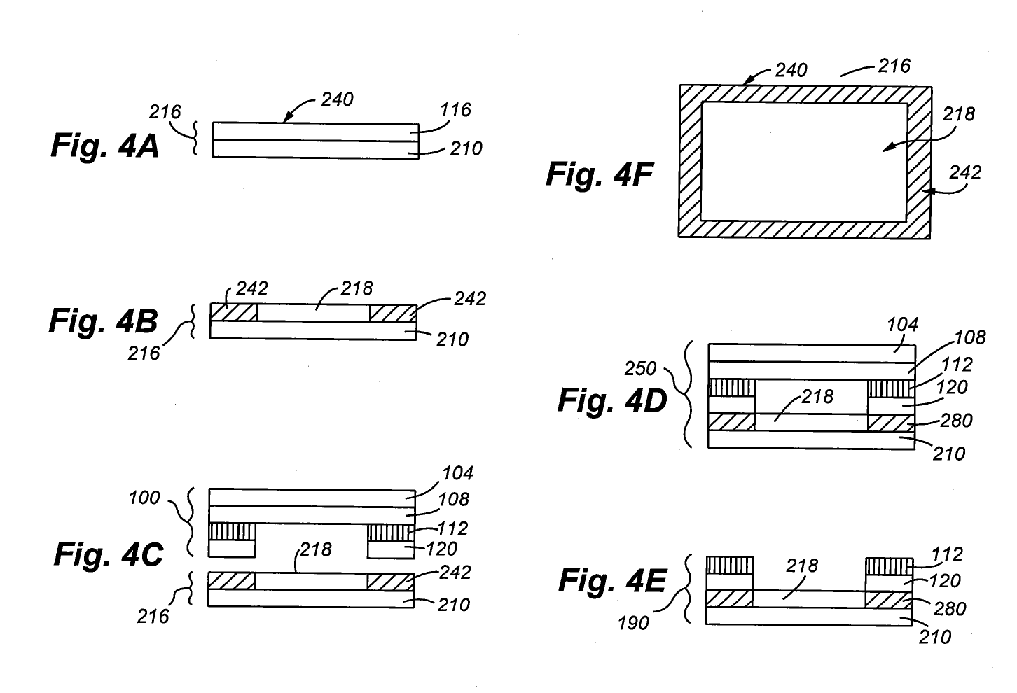

FIGS. 4A-F depict another embodiment of the present invention wherein insert 216, FIG. 4A, is comprised of insert material 116 and a backing material 210. In a preferred embodiment backing material 210 is a solid adhesive or a solid material having an adhesive, even more preferred the backing material is a solid, activatable thermosetting adhesive or a backing material having a solid, activatable thermosetting adhesive. Yet even more preferred backing material 210 is a solid, activatable thermosetting adhesive.

In a preferred embodiment insert material 116 comprises a textile material, even more preferred is a woven textile, with enhanced surface texture and luster having an embroidered and/or hand-stitched embroidered appearance. Yet even more preferred is a loosely woven, highly textured, dimensionalized polyester fabric with high luster such as ObiTex™. The textile material may or may not contain a printed image such as a sublimation dye printed image.

In step 204, surface 240 of insert 216 is treated with a laser. Treated zone 242 of surface 240 of insert 216 (FIG. 4B) is laser-ablated in registration with the area(s) that permanent adhesive 120 (FIG. 4C) will contact insert 216. In step 204 at least some of insert 116 material within treatment zone 242 is removed in the ablation process to provide a surface of backing material 210 for contacting adhesive 120 in step 212, preferably at least 50% of insert material 116 is removed from area 242, more preferably at least 75% of insert material 116 is removed from area 242. Even more preferably at least 98% of insert material 116 is removed from area 242 in the ablation process 204 to provide an adhesive surface for contacting adhesive 120 in step 212.

Preferably the laser produces at least enough energy to sufficiently vaporize the material being removed form the insert. In a preferred embodiment, the laser power output is at least about 1000 watts. In a more preferred embodiment, the laser power output is about 1000 to 2500 watts. In an even more preferred embodiment, the laser energy output is sufficient to at least vaporize the textile surface of inserts comprised of textile material.

Another preferred embodiment is precision cutting and removal of at least some of insert material 116 to provide exposed insert 218. Specifically, precision cutting is afforded with a high-energy laser beam directed by a precision indexing mechanism. In an even more preferred embodiment the high-energy laser beam heat seals the cut textile fiber and/or yarn ends to provide a crisp, clean, sealed cut with little, if any, frayed or loose ends. As will be appreciated, any laser-ablation encroachment in area 218 is undesirable and can decrease the quality and artistic value of insert 216.

Flock transfer 100, FIG. 4C, is fabricated as disclosed above. In step 212, transfer 100 is contacted in registration with insert 216, that is laser-ablated treatment zone 242 is contacted in registration with adhesive 120, FIG. 4D. In step 214, transfer 100 is thermally bonded to insert 216. Preferably, permanent adhesive 120 and the permanent adhesive comprising the backing material 210 are A- and/or B-staged thermosetting adhesives that are at least most fully B- and/or C-stage during thermal bonding step 214. In thermal bonding step 214, the softened and/or liquefied (A- and/or B-staged) permanent adhesive 120 and the permanent adhesive comprising the backing material 210 should be substantially capable of mutually wetting each other and should be at least substantially chemically similar or compatible, preferably they should be mutually soluble, more preferably the adhesive comprising the backing material 210 and adhesive 120 should be mutually soluble and capable of cross-linking with one another.

In a preferred embodiment adhesive 120 diffuses to some depth in backing material 210 and the adhesive comprising backing material 210 diffuses in adhesive 120 to another depth, the combined diffusion depth is also depicted by zone 280. In a more preferred embodiment, the adhesion process is also accompanied by cross-linking, wherein chemical entities in adhesive 120 react with chemical entities in the backing material adhesive 210 to form covalent bonds, mutually cross-linking adhesive 120 and backing adhesive 210 to form a continuous cross-linked adhesive network binding flock 112 with insert 216.

A more preferred embodiment is backing material 210 comprised at least mostly of an adhesive. Even more preferred is an backing material 210 comprising nylon or polyester.

An adhesive-to-adhesive bond is preferred for its strength and ease of perfecting. More preferred is a backing adhesive 210 to adhesive 120 bond where adhesive 120 and backing adhesive 210 are chemically compatible and/or chemically equivalent, in such a case the adhesive 120 and backing adhesive 210 can at least be substantially mutually wettable and soluble and thereby capable of intermingling to form an adhesive bond. Chemically similar or compatible adhesive 120 and backing adhesive 210 can also be substantially capable of mutually cross-linking, that is, adhesive 120 and backing adhesive 210 can form covalent bonds, one of the strongest forms of adhesion. Chemically similar or compatible adhesive 120 and backing adhesive 210 having polarizable groups (such as, carbonyl and/or amino) are also capable providing adhesion by dispersive and/or electrostatic forces. While not wanting to be bound by any theory, any mechanical interlocking due to surface roughness provided to treatment zone 242 during ablation will enhance diffusive mixing, dipole-dipole interactions and formation of covalent between adhesive 120 and backing adhesive 210.

An even more preferred embodiment is a backing adhesive 210 to adhesive 120 bond, where adhesive 120 and backing adhesive 210 are substantially the same activatable thermosetting adhesive; in such a case, the adhesives are substantially mutually wettable and soluble and to intermingling to cross-link to form product 298, a continuous cross-linked adhesive network binding flocked assembly 100 with insert 216. Product 298 can or cannot include carrier sheet 104 and release adhesive 108 as respectively depicted in articles 250 and 190 in respective FIGS. 4C and 4E.

Although the adhesive 120 can be a thermosetting adhesive, it is preferred that adhesive 120 be thermoplastic while backing adhesive 210 is thermosetting. More preferably, the backing adhesive 210 is at least mostly fully B-staged during thermal bonding step 212; an even more preferably that backing adhesive 210 be at least mostly fully C-staged during step 212. The adhesives are at least most, if not fully, interlocked, as depicted by zone 280, by at least one of the following: mechanical, chemical and physical. The adhesive 120 is preferably thermoplastic so that it melts and flows in response to heating.

Backing material 210 can also comprise a polymeric material, a polymeric material having a thermosetting adhesive component, or a thermoplastic adhesive. It can be appreciated that, while not wanting to be bound by any theory, laser-ablation of insert 216 to expose at least some if not at least most of backing material 210 within treatment zone 242 can afford enhanced adhesion.

When backing material 210 is a polymeric material, enhanced adhesion can be afforded by at least one of the following: mechanical interlocking; dispersive forces; chemisorption if the polymer contains chemical entities that can react with chemical entities in adhesive 120; electrostatic attractive dipolar forces between polymeric material 210 and adhesive 120; and diffusion intermingling of polymeric material 210 and adhesive 120. When backing material 210 is a polymeric material having a thermosetting adhesive component, the above disclosure relative to a polymeric backing material can apply and the following can also at least enhance adhesion by one of the following: mechanical interlocking can be enhanced by the intermingling of thermosetting adhesive 120 within the polymeric matrix of backing material 210; enhanced chemisorption if the thermosetting adhesive component of backing material 210 and adhesive 120 are capable of cross-linking; and enhanced diffusion. When backing material 210 is a thermoplastic, adhesion can be afforded by at least one of the following: mechanical interlocking where adhesive 120 penetrates the roughened surface of the thermoplastic adhesive and is C-staged within the roughened thermoplastic surface, thereby mechanically interlocking the thermoplastic roughened surface of backing material 210 with C-staged thermosetting adhesive 120; dispersive forces; electrostatic attractive forces between the thermosetting and thermoplastic adhesives; and diffusion intermingling of the thermoplastic backing material 210 and thermosetting adhesive 120.

Another embodiment of the present invention is controlling the heating process to soften and/or liquefy adhesive 120 and backing material and/or backing adhesive 210 to provide for optimum adhesive bonding of adhesive 120 and backing material or backing adhesive 210 in the most economic, cost-efficient and timely manner. It has been found that optimally strong adhesive bonds are formed more rapidly (and cost-effectively) when a thermal gradient is formed between adhesive 120 and backing material and/or backing adhesive 210.

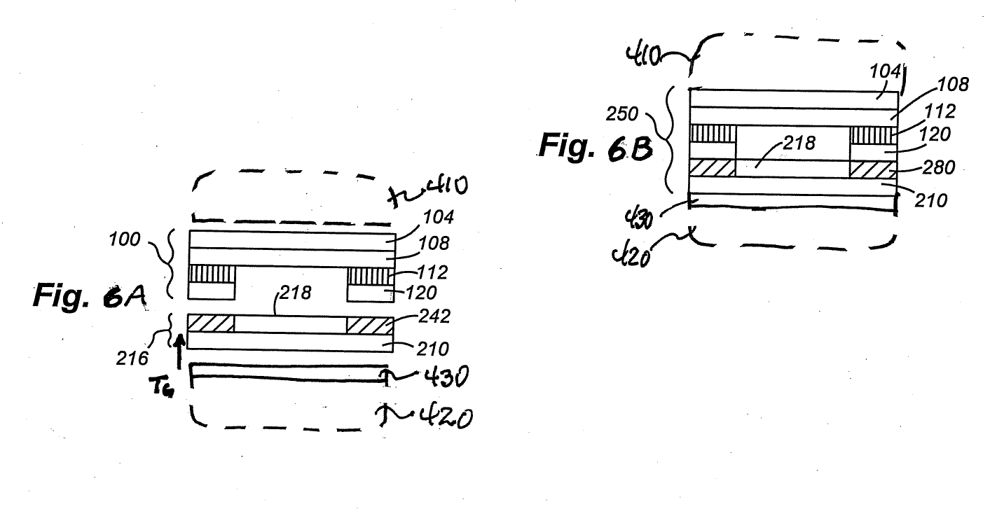

An embodiment of the present invention is depicted in FIGS. 6A and 6B, a thermal source 430 that applies thermal energy to insert 216 to produce a thermal gradient within insert 216, with the direction of heat migration being indicated by TG. The thermal energy source 430 can be a component of an optional pressuring applying device comprising elements 410 and 420.

In one embodiment, the thermal energy source applies thermal energy to insert 216 to heat insert 216 prior to contacting insert 216 with flocked assembly 100 (that is, the thermal bonding step 214 proceeds or is substantially sequential with contacting step 212). This is done by placing the insert 216 in the presence of the source 430 before the insert 216 is contacted with the flocked assembly 100. After the insert 216 is at a desired temperature, it is contacted with the flocked assembly 100. Heating roughened insert 216 prior to contacting with flocked assembly 100 provides a preferential heating of adhesive 120 surface, to preferentially soften and/or liquefy the surface of adhesive 120 in contact with roughened insert 216, thereby providing for enhanced flow of adhesive 120 along and into the roughened treatment zone 242 and enhanced adhesion of flocked assembly 100 to insert 216.

Another preferred embodiment is positioning heated insert 216 below flocked assembly 100 during the contacting step 212 (again thermal bonding step 214 proceeds or is substantially sequential with contacting step 212), thereby gravity assists the flow of softened and/or liquefied adhesive 120 along and into the roughened treatment zone 242, providing for enhanced adhesion of flocked assembly 100 to insert 216.

Yet another embodiment is applying pressure during the thermal bonding step 214 with a pressure with compressing components 410 and 420 to further enhance the flow of softened and/or liquefied adhesive 120 into the roughened treatment zone 242. More preferred is pressure in a downward direction towards the thermal energy source. It is appreciated that the melt and/or softening temperature of backing material is preferably sufficiently high enough that backing material 210 does not deform or melt during the thermal bonding step 214. That is, it is desired that the adhesive 120 melt and flow while the adhesive 210 not melt and flow. Melting or flowing of the adhesive 210 could impair rather than assist formation of the desired adhesive-to-adhesive contact.

It is thus appreciated that when thermal energy is applied to insert 215 the melt (and/or softening) temperature of the backing adhesive material 210 is preferably greater than the melt and/or softening temperature of the adhesive 120, more preferably the melt temperature of backing adhesive material 210 is at least 20° C. greater than the melt temperature of adhesive 120, and that the maximum temperature of the backing adhesive 210 realized during the thermal bonding step 212 is less than the softening and/or melting temperature of the backing adhesive 210.

The thermal gradient, from hot to cool, can be from flocked assembly 100 to insert 216, or from insert 216 to flocked assembly 100, with the latter thermal gradient of heat flow from the warmer insert to the cooler flocked insert being preferred.

In this preferred thermal gradient embodiment, the softening of adhesive 120 and the backing material 210 or backing adhesive 210 and the respective flow properties of adhesive 120 and backing adhesive 210 is controlled in part by the thermal properties of insert 216; wherein thinner and/or more thermally conductive insert materials are more preferred than thicker and/or less thermally conductive materials. Thinner and/or more thermally conductive materials provide for steeper (greater) heat gradients and better and more rapid flow properties of adhesive 120 and backing (material and/or adhesive) 210.

Yet another embodiment includes applying pressure in conjunction with the thermal gradient to provide an additional vector to direct at least some if not most of the flow to provide for the intermingling of adhesive 120 and backing (material and/or adhesive) 210.

The flow properties of adhesive 120 and backing (material and/or adhesive) 210 is determined at least in part by the melt (or softening) temperature of adhesive 120; the melt (and/or softening) temperature of backing material and/or adhesive 210 and the direction of the thermal gradient.

While not wanting to be bound by theory, in the case of the preferred thermal gradient (from warmer insert to cooler flocked assembly) at least the following illustrative flows are possible: (a) when backing material and/or backing adhesive 210 has at least a lower melt (and/or softening) temperature than adhesive 120, the lower melting backing 210 components will at least flow in greater part to adhesive 120 than adhesive flow 120 towards backing 210; (b) when adhesive 120 has at least a lower melt (and/or softening) temperature than backing 210, the lower melting adhesive 120 will at least flow in greater part to backing 210 than backing material 210 flow towards adhesive 120; and (c) when adhesive 120 and backing material and/or backing adhesive 210 have substantially about equal melt (and/or softening) temperatures, the flow will at least in part from warmer (that is the least warmer and therefore more likely softer, and/or more liquefied and/or less viscous backing material) to the more likely cooler and therefore more likely less soft, and/or less liquefied and/or more viscous adhesive 120.

A number of variations and modifications of the invention can be used. It would be possible to provide for some features of the invention without providing others.

For example in one alternative embodiment, the present invention is not limited to non-compatible inserts but may be used to adhere flock to any desired material. For example, the roughened material may be a polycarbonate substrate that is formed into a three-dimensional flocked structure for in mold applications. This product is further described in U.S. patent application Ser. No. 10/394,357, filed Mar. 21, 2003, which is incorporated herein by this reference.

Another alternative embodiment of the present invention is not limited to modifying the non-compatible insert by laser-ablation. For example, the non-compatible insert can be chemically modified, as for, example by chemically etching the surface. The etching can roughen the surface to increase adhesion, or chemically remove (for example by dissolving) the non-compatible surface, as for example, to expose a more compatible surface. Chemical surface modification processes can also include masking techniques to selectively protect areal surfaces not in registration with the adhesive and selectively expose areal surfaces in registration with the adhesive. Chemical modification can also include chemical conversion of the treated surface to a chemical or chemical entity (or entities) that increase adhesion, such as, but not limited to, forming a chemical entity (or entities) that provide for enhanced adhesion. Chemical modification can also include cleaning of the insert surface to increase adhesion, such as, but not limited to the removal of physical debris, processing chemicals (such as lubricants, sizing agents, anti-static agents, etc.), oils (such as from processing machinery and/or physical handling). Another surface modification embodiment includes surface modification by charged particles, such as but not limited electrical or plasma, wherein the high-energy charged particles cut, roughen and/or modify the insert surface to provide a surface with improved adhesion. A beam, or organized arrangement of the charged particles, can be used in a manner analogous to laser-ablation processes disclosed above to modify the insert surface, that is, for example, remove portions of the insert, cut grooves, bore-holes and so forth. Yet another surface modification embodiment includes mechanically modifying the insert surface, such as but not limited to removing or modifying the surfaced as disclosed above, as for example where the surface can be removed by a cutting device, or by impingement with a high-energy stream (of a solid, liquid or gas), or by ablation (e.g., grinding). Another embodiment includes ultra-sonically cleaning and/or modifying of the insert surface.

In another embodiment, the surface roughening is used to increase surface adhesion in a direct flocking application. In such an application, the surface is roughened and contacted with the adhesive before being contacted with the flock by direct flocking.

The present invention, in various embodiments, includes components, methods, processes, systems and/or apparatus substantially as depicted and described herein, including various embodiments, subcombinations, and subsets thereof. Those of skill in the art will understand how to make and use the present invention after understanding the present disclosure. The present invention, in various embodiments, includes providing devices and processes in the absence of items not depicted and/or described herein or in various embodiments hereof, including in the absence of such items as may have been used in previous devices or processes, e.g., for improving performance, achieving ease and\or reducing cost of implementation.

The foregoing discussion of the invention has been presented for purposes of illustration and description. The foregoing is not intended to limit the invention to the form or forms disclosed herein. In the foregoing Detailed Description for example, various features of the invention are grouped together in one or more embodiments for the purpose of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate preferred embodiment of the invention.

Moreover, though the description of the invention has included description of one or more embodiments and certain variations and modifications, other variations and modifications are within the scope of the invention, e.g., as may be within the skill and knowledge of those in the art, after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

What is claimed is:

1. A method for forming a flocked article, comprising:
(a) roughening a surface of a material;
(b) providing flock; and
(c) contacting the roughened surface with a first adhesive, wherein the first adhesive is positioned between the flock and the roughened surface.

2. The method of claim 1, wherein the roughening step (a) further comprises at least one of: a physical roughening; a chemical roughening; or a combination thereof.

3. The method of claim 1, wherein modifying step (a) further comprises:
roughening the surface with electromagnetic radiation, wherein the electromagnetic radiation removes at least some of the material; and wherein contacting step (c) further comprises:
producing an adhesion force between the first adhesive and the roughened surface.

4. The method of claim 1, wherein the material is a non-compatible insert having a first and second opposing surfaces, wherein the first surface has at least one areal surface roughened in registration with the first adhesive; and
wherein contacting step (c) further comprises:
contacting the first adhesive in registration with the at least one areal roughened surface.

5. The method of claim 4, wherein the second opposing surface is adhered to a second material.

6. The method of claim 5, wherein roughening step (a) further comprises:
having at least one areal zone contained within the areal modified surface,
removing at least most of the non-compatible insert within the at least one areal zone; and
exposing the second material within the at least one areal zone; and
wherein contacting step (c) further comprises:
contacting the adhesive with the second material within the at least one areal zone.

7. The method of claim 5, wherein the second material is a second adhesive, and wherein the first adhesive and second adhesive form an adhesive bond.

8. A flocked article, comprising:
a material having roughened and unroughened surfaces;
a plurality of flock fibers; and
a first adhesive positioned between the flock fibers and the roughened surface.

9. The flocked article of claim 8, wherein the roughened surface has a surface energy at least about equal to or greater than that of the first adhesive and at least greater than that of the unroughened surface.

10. The flocked article of claim 8, wherein the roughened surface of the material is in registration with the first adhesive.

11. The flocked article of claim 8, further comprising a second adhesive, wherein the second adhesive is positioned on a second surface opposing the roughened surface.

12. The flocked article of claim 11, wherein the roughened surface comprises a plurality of regions where the first and second adhesives are in contact.

13. The flocked article of claim 8, wherein the material comprises at least in part a woven textile material.

14. A method of manufacturing a flocked article, comprising:
roughening only a portion of a first surface of a material;
forming a flock transfer having an adhesive surface; and
contacting the adhesive surface with the roughened surface.

15. The method of claim 14, wherein roughening further comprises cutting, abrading, removing, or a combination thereof of at least some of an areal portion of the modified surface.

16. The method of claim 14, wherein the contacting step further comprises:
contacting the adhesive and roughened surfaces in registration; and
wherein the method further comprises:
laminating the contacted the adhesive and roughened surfaces, wherein the laminating and contacting steps can be preformed substantially simultaneously or sequentially.

17. The method of claim 16, wherein the material has a second surface opposing the first surface, wherein the second surface comprises another adhesive.

18. The method of claim 17, wherein the lamination step further comprises:
heating to a sufficient temperature to soften at least one of the adhesive surface and another adhesive;
creating a softened adhesive flow comprised of the at least one softened adhesive and a thermal gradient, wherein the adhesive flow is along the thermal gradient towards the roughened surface;
contacting the at least one softened adhesive and the roughened surface;
contacting the adhesive surface and another adhesive, wherein at least one of the adhesive surface and other adhesive is in a softened state; and
forming adhesive bonds between the adhesive surface, another adhesive, and roughened surface.

19. The method of claim 16, wherein the material has a second surface opposing the first, and further comprising:
contacting the second surface with another adhesive film.

20. The method of claim 19, wherein the lamination step further comprises:
heating to a sufficient temperature to soften at least one of the adhesive surface and another adhesive;
creating a softened adhesive flow comprised of the at least one softened adhesive and a thermal gradient, wherein the adhesive flow is along the thermal gradient towards the roughened surface;
contacting the at least one softened adhesive and the roughened surface;
contacting the adhesive surface and another adhesive, wherein at least one of the adhesive surface and other adhesive is in a softened state; and
forming adhesive bonds between the adhesive surface, another adhesive, and roughened surface.

21. A method of forming a flocked article, comprising:
(a) ablating a surface of a material with a laser to form a laser-ablated surface;
(b) providing a plurality of flock fibers; and
(c) contacting the ablated surface with an adhesive, wherein the adhesive is positioned between the ablated surface and plurality of flock fibers.

22. The method of claim 21, wherein the laser ablating step comprises cutting, melting, vaporizing, removing, or a combination thereof of at least some of an areal portion of the surface.

23. The method of claim 21, wherein the contacting step further comprises:
contacting the adhesive and laser-ablated surface in registration; and
wherein the method further comprises:
laminating the contacted in registration with the adhesive and laser-ablated surface, wherein the laminating and contacting steps can be performed substantially simultaneously or sequentially.

24. The method of claim 21, wherein the material has a second surface opposing the first surface, wherein the second surface comprises another adhesive;
wherein the lamination step further comprises:
heating to a sufficient temperature to soften at least one of the adhesive surface and another adhesive;
creating a softened adhesive flow comprised of the at least one softened adhesive and a thermal gradient, wherein the adhesive flow is along the thermal gradient towards the laser-ablated surface;
contacting the at least one softened adhesive and the laser-ablated surface;
contacting the adhesive surface and another adhesive, wherein at least one of the adhesive surface and other adhesive is in a softened state; and
forming adhesive bonds between the adhesive surface, another adhesive, and laser-ablated surface.

25. The method of claim 21, wherein the material comprises in part a woven textile, and wherein the laser-ablation vaporizes the woven textile.
